(19) United States
(12) Patent Application Publication
(10) Pub. No.: US 2007/0133943 A1
(43) Pub. Date: Jun. 14, 2007

(54) Broadcast recording apparatus and broadcast recording method

(75) Inventors: Kazuhiko Muguruma, Hino-shi (JP); Masaki Tsuchida, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/605,999

(22) Filed: Nov. 30, 2006

(30) Foreign Application Priority Data
Nov. 30, 2005 (JP) 2005-346902

(51) Int. Cl. H04N 5/91

(52) U.S. Cl. 386/83

(57) ABSTRACT

According to one embodiment, a broadcast recording apparatus has a temporary recording region portion that records broadcast contents from a tuner, a storage region portion that records broadcast contents, and control unit that carries out recording of broadcast contents within a range of a time limit in the temporary recording region, that carries out loop image recording for making overwrite recording in the temporary recording region in which recording has already been made if the time limit is exceeded, that, if an operating signal is supplied at this time, copies broadcast contents recorded in a temporary recording region to a storage region, and that disables overwriting into the temporary recording region until copying is completed.

### CROSS-REFERENCE TO RELATED APPLICATIONS

This application is based upon and claims the benefit of priority from Japanese Patent Application No. 2005-346902, filed on Nov. 30, 2005, the entire contents of which are incorporated herein by reference.

### BACKGROUND

1. Field

One embodiment of the invention relates to a broadcast recording apparatus for recording a video image signal in a hard disk drive, and particularly to a broadcast recording apparatus having a memory region for carrying out temporary recording and a memory region for carrying out long recording, and a broadcast recording method.

2. Description of the Related Art

Recently, with prevalence of a digital device, a broadcast receiving apparatus such as a hard disk recorder has been generally known. A plenty of video image information can be recorded and reproduced more easily than a case of a recording and reproducing processing operation by a conventional video tape recorder (VTR). In such a broadcast receiving apparatus, reservation image recording or the like can be carried out by simple operation so that a plenty of video image and voice information is recorded in a storage region. Therefore, a variety of hard disk image recording methods become effective according to a user's program viewing mode as well as merely recording broadcast contents in one hard disk.

In patent document 1 (Jpn. Pat. Appln. KOKAI Publication No. 2002-142177), there is disclosed a broadcast program recording apparatus in which a plurality of hard disk drives are provided, one hard disk drive is used for overwrite recording of program contents that are repeating image recording within a predetermined time interval, and the other hard disk drive is used for storage image recording for storing the overwritten and recorded program contents for a long period of time.

However, in the above described conventional technique, when a copy processing operation for a storage region is instructed with respect to broadcast contents loop image-recorded in a temporary image recording region, the broadcast contents being recorded in the temporary image recording region are subjected to a copy processing operation for the storage region. However, at this time, there is a case in which loop image recording is further carried out. Therefore, there is a problem that, depending on process of loop image recording, the broadcast contents in copy processing operation is erased, although such copy processing operation has not been completed yet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a configuration of a broadcast recording apparatus according to an embodiment of the present invention;

FIG. 2 is a block diagram depicting another example of a configuration of the broadcast recording apparatus according to an embodiment of the present invention;

FIG. 3 is a block diagram depicting another example of a configuration of the broadcast recording apparatus according to an embodiment of the present invention;

FIG. 4 is a block diagram depicting another example of a configuration of the broadcast recording apparatus according to an embodiment of the present invention;

FIG. 5 is an illustrative view showing an example of a remote controller device for operating the broadcast recording apparatus;

FIG. 6 is an illustrative view showing an example of a first copy processing operation of the broadcast recording apparatus;

FIG. 7 is an illustrative view showing an example of a second copy processing operation of the broadcast recording apparatus;

FIG. 8 is an illustrative view showing an example of third and fourth copy processing operations of the broadcast recording apparatus;

FIG. 9 is an illustrative view showing an example of a fifth copy processing operation of the broadcast recording apparatus;

FIG. 10 is an illustrative view showing an example of a sixth copy processing operation of the broadcast recording apparatus;

FIG. 11 is a flow chart showing an example of the first copy processing operation of the broadcast recording apparatus;

FIG. 12 is a flow chart showing an example of the second copy processing operation of the broadcast recording apparatus;

FIG. 13 is a flow chart showing an example of the third copy processing operation of the broadcast recording apparatus;

FIG. 14 is a flow chart showing an example of the fourth copy processing operation of the broadcast recording apparatus;

FIG. 15 is a flow chart showing an example of the fifth copy processing operation of the broadcast recording apparatus; and

FIG. 16 is a flow chart showing an example of the sixth copy processing operation of the broadcast recording apparatus.

### DETAILED DESCRIPTION

Various embodiments according to the invention will be described hereinafter with reference to the accompanying drawings. In general, according to one embodiment of the invention, there is provided a broadcast recording apparatus, comprising: a tuner unit which receives a broadcast signal, demodulates the received signal, and outputs broadcast contents; a temporary recording region portion which records the broadcast contents; a storage region portion which records the broadcast contents; and a control unit which makes control to record the broadcast contents within a range of a time limit in the temporary recording region portion, carry out loop image recording for making overwrite recording in the temporary recording region portion in which recording has been made if the time limit is exceeded, copy the broadcast contents recorded in the temporary recording region portion to the storage region portion if an operating signal is supplied while the loop image recording is carried out, and disable overwriting of the broadcast contents in the temporary recording region portion until the copy is completed.

In this broadcast recording apparatus, while broadcast contents after loop image-recorded in a temporary recording region A are copied to a storage region B, broadcast contents loop image-recorded in such a temporary recording region are disabled from being overwritten, whereby the loop image recording is made compatible with reliable copy processing operation for a storage region.

There is provided a broadcast recording apparatus capable of reliably carrying out loop image recording and storage image recording at the same time, respectively. Hereinafter, embodiments of the present invention will be described in detail with reference to the accompanying drawings.

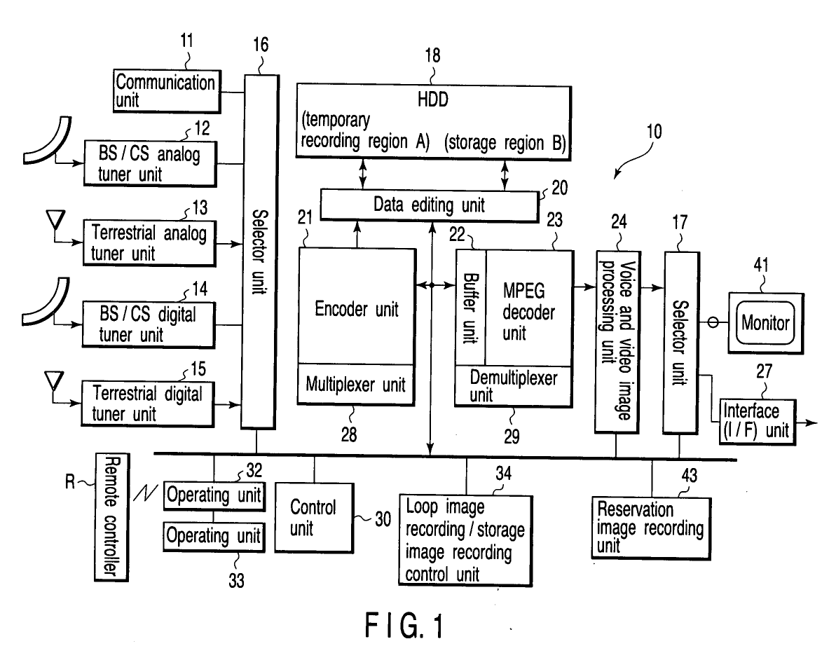

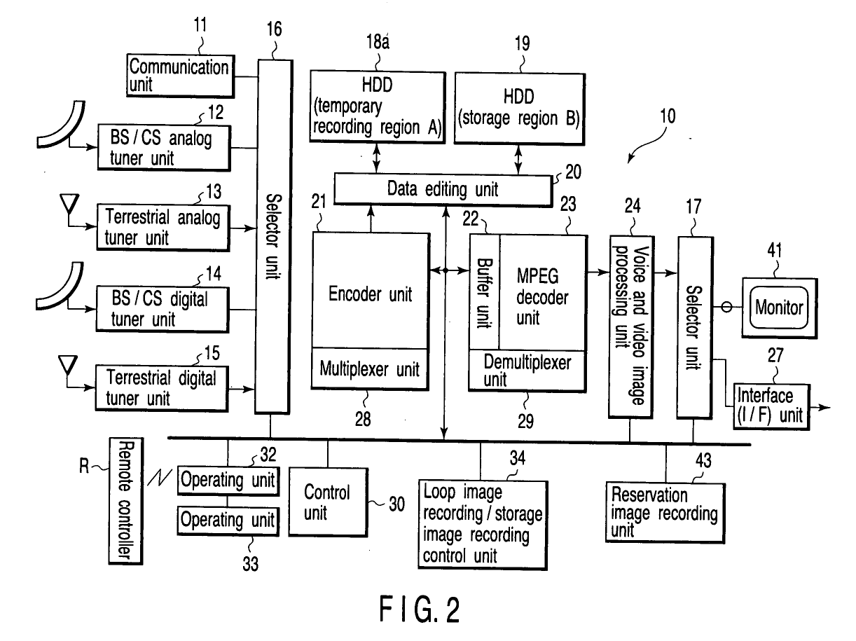

That is, FIG. 1 is a block diagram depicting an example of a configuration of a broadcast recording apparatus according to an embodiment of the present invention; and FIGS. 2 to 4 are block diagrams each depicting another example of a configuration of the broadcast recording apparatus according to an embodiment of the present invention.

<Broadcast Recording Apparatus According to an Embodiment of the Present Invention>

(Configuration)

First, a broadcast recording apparatus 10 shown in FIG. 1 is provided as an example of a digital television having a recording function while a tuner or the like is used as a source. However, a hard disk recorder having a tuner or the like and a recording function is also preferred similarly.

Therefore, while the following embodiments with reference to FIG. 1 will describe in detail a digital television having a recording function, it is possible to construe the embodiments as an explanation of a hard disk recorder having completely identical capabilities by separating a display 26 from the constituent elements shown in FIG. 1.

In FIG. 1, the broadcast recording apparatus 10 serving as a digital television has a hard disk drive 18. This hard disk drive 18 has a temporary recording region A used for loop image recording and a storage region B used for storage recording. In addition, a control unit 30 is connected to each unit via a data bus B to control a whole operation.

In addition, the broadcast recording apparatus 10 shown in FIG. 1 primarily comprises: an encoder unit 21 that configures an image recording side; an MPEG decoder unit 23 that configures a reproduction side; and a control unit 30 that controls an operation of an apparatus main body. The broadcast recording apparatus 10 has an input side selector 16 and an output side selector 17. A communication unit 11 such as a LAN, a so called satellite broadcast (BS/CS) analog tuner unit 12, a so called terrestrial analog tuner unit 13, a satellite broadcast (BS/CS) digital tuner unit 14, and a so called terrestrial digital tuner unit 15 are connected to the input side selector 16, thereby outputting a signal to the encoder unit 21. In addition, a satellite antenna is connected to the BS/CS analog tuner unit 12, a terrestrial antenna is connected to the terrestrial analog tuner unit 13, a satellite antenna is connected to the BS/CS digital tuner unit 14, and a terrestrial antenna is connected to the terrestrial digital tuner unit 15. In addition, the broadcast recording apparatus 10 has: an encoder unit 21; a signal editing unit 20 that receives an output from the encoder unit 21, and then, carries out a desired data processing operation such as data editing; and a hard disk drive 18 connected to the signal editing unit 20 and having a storage region A for loop image recording and a storage region B for storage image recording. Further, the broadcast recording apparatus 10 has: an MPEG decoder unit 23 for receiving and decoding a signal from the hard disk drive unit 18; an encoder unit 21; a buffer unit 22; an MPEG decoder unit 23; a multiplexer unit 28; a demultiplexer unit 29; a control unit 30; a loop image recording/storage image recording control unit 34; and a reservation image recording unit 43. These units each are connected to the control unit 30 via the data bus B. Further, an output from the selector unit 17 is supplied to a display 26 or is supplied to an external device via an interface unit 27 for making communication with the external device.

Further, the broadcast recording apparatus 10 has an operating unit 32 connected to the control unit 30 via the data bus B and receiving a user operation or an operation of a remote controller R. Here, the remote controller R enables operations that are substantially identical to those of the operating unit 32 provided at a main body of the broadcast recording apparatus 10. This remote controller enables a variety of settings such as supply of a recording or reproducing command for the hard disk drive, supply of an edit command, a tuner operation, reservation image recording setting and the like.

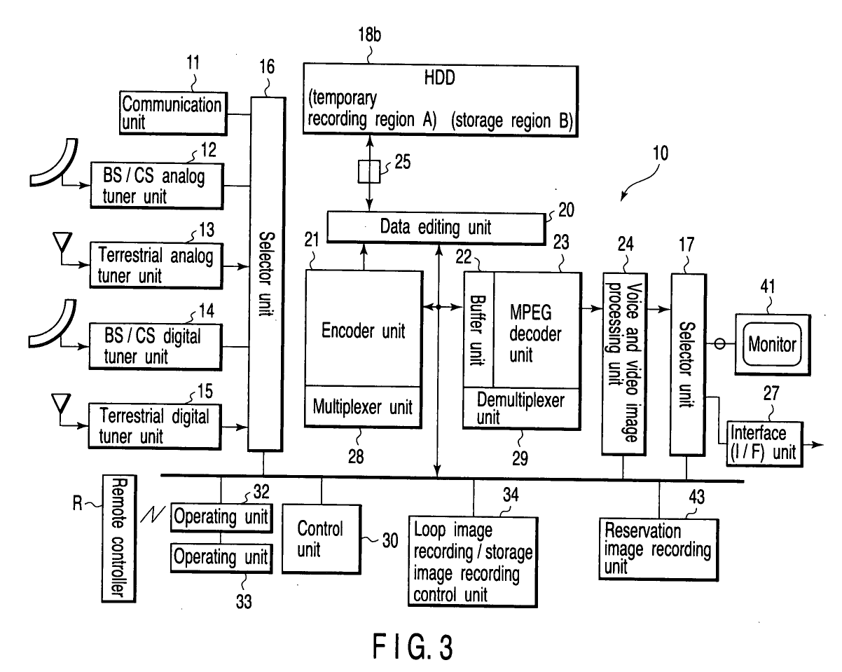

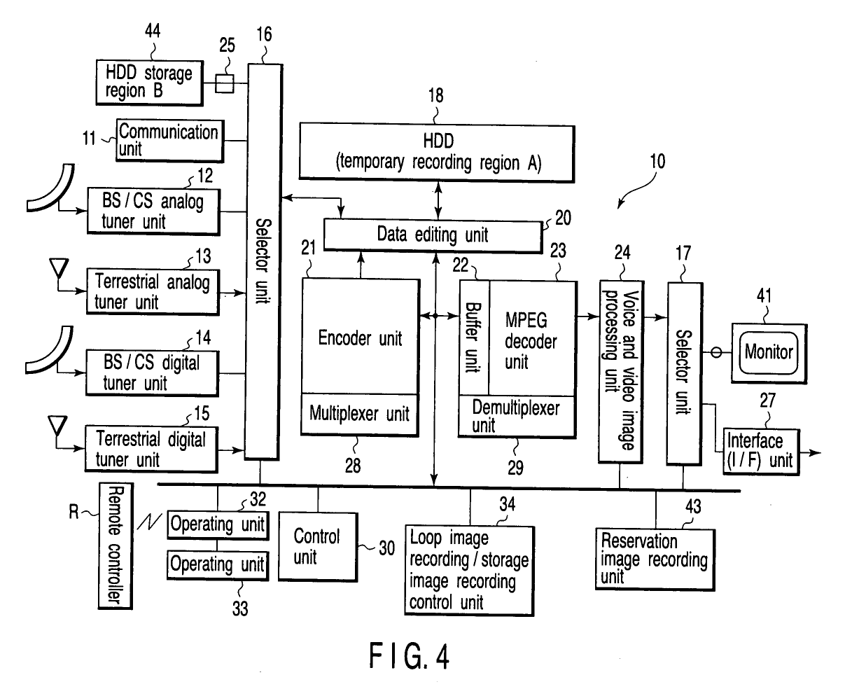

In addition, as shown in FIG. 2, it is also preferable that the temporary recording region A and the storage region B of the broadcast recording apparatus 10 according to an embodiment of the present invention be provided in independent hard disk drives 18 and 19. In addition, as shown in FIG. 3, it is preferable that a hard disk drive 18b of the broadcast recording apparatus 18 according to an embodiment of the present invention be an external hard disk drive removable via an interface 25. Further, as shown in FIG. 4, in addition to the built-in hard disk drive 18, it is preferable that an external hard disk drive 44 be further provided, and the storage region B be provided therein.

(Basic Operation)

—Reproduction of Broadcast Contents

In the broadcast recording apparatus 10 serving as the thus configured digital television, in accordance with an operating signal responsive to an operation of a user's remote controller R or the operating unit 32, a broadcast signal is received, and then, the broadcast contents from the BS/CS analog tuner unit 12, the terrestrial analog tuner unit 13, the BS/CS digital tuner unit 14, or the terrestrial digital tuner unit 15 are displayed on the display 26, under the control of the control unit 30 or the like.

—Recording Processing Operation

Now, an operation at the time of recording including those according to other embodiments will be described in detail. As an input side of the broadcast recording apparatus 10, a communication unit 11 such as a LAN is connected to an external device, thereby making communication with a program information providing server S or the like through a communication channel such as the Internet via a modem M or the like, or downloading contents and information or the like. In addition, the BS/CS analog tuner unit 12, the terrestrial analog tuner unit 13, the BS/CS digital tuner unit 14, and the terrestrial digital tuner unit 15 select a broadcast signal as a channel and demodulate it via an antenna, and input a video image signal and a voice signal. In addition, there is not necessarily provided only one tuner unit. For example, two or three tuner units such as a terrestrial broadcast tuner unit and a BS/CS tuner unit may be provided to function in parallel to each other in response to a request for reservation image recording.

The previously described communication unit 11 may be an IEEE1394 interface and is capable of receiving digital contents from an external device over a network. In addition, it is also possible to receive a luminance signal, a color difference signal, a video image signal such as a composite signal, and a voice signal from an input terminal (not shown). These signals are selectively supplied to the encoder unit 21 by means of the selector 16 controlled by the control unit 30 or the like while inputs are controlled.

The encoder unit 21 has: a video use and an audio use analog/digital converter for digitizing an analog video signal or an analog audio signal inputted by means of the selector 16; a video encoder, and an audio encoder. For example, a subsidiary video image encoder is also included. An output from the encoder 21 is converted into a compression format such as predetermined MPEG, and the converted output is supplied to the previously described control unit 30.

In addition, the BS/CS analog tuner 12 or the like is not always incorporated. Preferably, this tuner is externally provided via a data input terminal to supply the received digital signal to the encoder unit 21 or the control unit 30 via the selector unit 16.

Here, in the apparatus shown in FIG. 1, information (pack such as video, audio, and subsidiary video image data) encoded by means of the encoder unit 21 and produced management information or digital information can be supplied to and recorded in the hard disk drives 18 and 19 via the control unit 30 without being encoded. The BS/CS analog tuner unit 12 and the terrestrial analog tuner unit 13 encode broadcast contents outputted therefrom at the encoder unit 21, and record the encoded contents in the hard disk drive 18 or the like. In addition, in the case of the BS/CS digital tuner 14 and the terrestrial digital tuner unit 15, the outputted broadcast contents include broadcast contents for a plurality of channels. The broadcast contents of a desired channel are demultiplexed by means of the demultiplexer unit 29. Further, management information is multiplexed by means of the multiplexer unit 28 to rewrite the management information for a plurality of channels into a management signal for the demultiplexed desired channel. In addition, the multiplexed broadcast contents are recorded in the hard disk drive 18 or the like as it is without carrying out an encode processing operation of broadcast contents from the analog tuner unit at the encoder unit.

The signal editing unit 20 enables an edit processing operation such as partially deleting broadcast contents of a plurality of programs recorded in the hard disk drive 18 or the like, or alternatively, connecting objects of different programs to each other.

—Reproducing Processing Operation or the Like

Now a processing operation of reproducing recorded information including those according to other embodiments will mainly be described in detail. The MPEG decoder unit 23 comprises a video processor for properly combining a decoded subsidiary video image with a decoded main video image, and then, superimposing a menu, a highlight button, subtitles or any other subsidiary video image on a main video image to be outputted.

An output audio signal of the MPEG decoder unit 23 is supplied to a speaker after being analog-converted by means of a digital/analog converter (not shown), via the selector unit 17 or is supplied to an external device via the I/F 27. The selector unit 17 is controlled by a select signal from the control unit 30. In this manner, the selector unit 17 can directly select a signal having passed through the encoder unit 21 when a digital signal from each of the tuner units 12, 13, 14, and 15 is directly monitored.

—Reservation Image Recording Processing Operation

In addition, based on electronic program information acquired from the communication unit 11 or the like, an image recording reservation processing operation can be made in accordance with a program specified by an operation of a user's remote controller or the like using a reservation image recording unit 43. Based on the reserved reservation image recording information and by working of the control unit 30 and the reservation image recording unit 43, when a reservation time has come, broadcast contents obtained by demodulating the program information received from the BS/CS analog tuner unit 12, the terrestrial analog tuner unit 13, the BS/CS digital tuner unit 14, and the terrestrial digital tuner unit 15 are recorded (reserved and image-recorded) in the hard disk drive 19 or the like.

The broadcast recording apparatus 10 according to the present embodiment has a comprehensive function, as described above. A recording/reproducing processing operation for the hard disk drive 18 or the like is carried out with respect to a plurality of sources. In addition to the hard disk drive 18 or the like, it is also preferable to carry out a recording/reproducing processing operation similarly while connecting an optical disk drive, although not shown, to the data editing unit 20 or the like.

<Loop Image Recording and Storage Image Recording Processing Operation According to an Embodiment of the Present Invention>

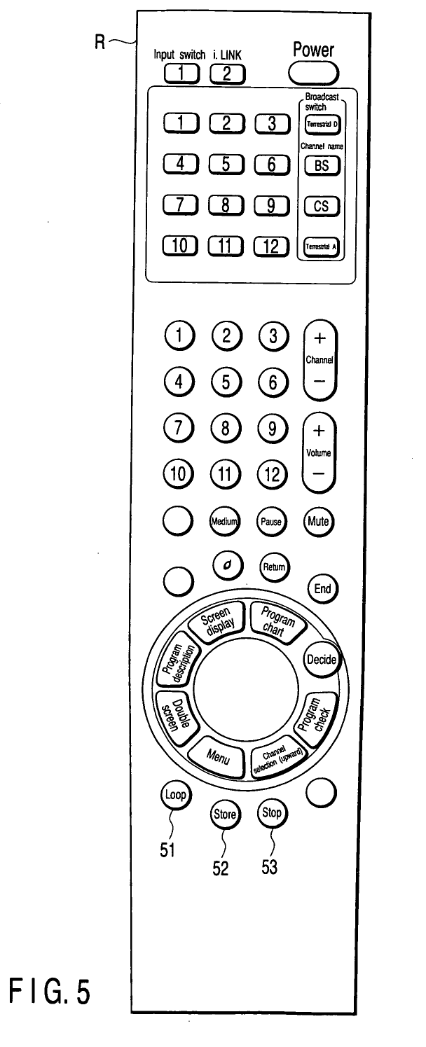

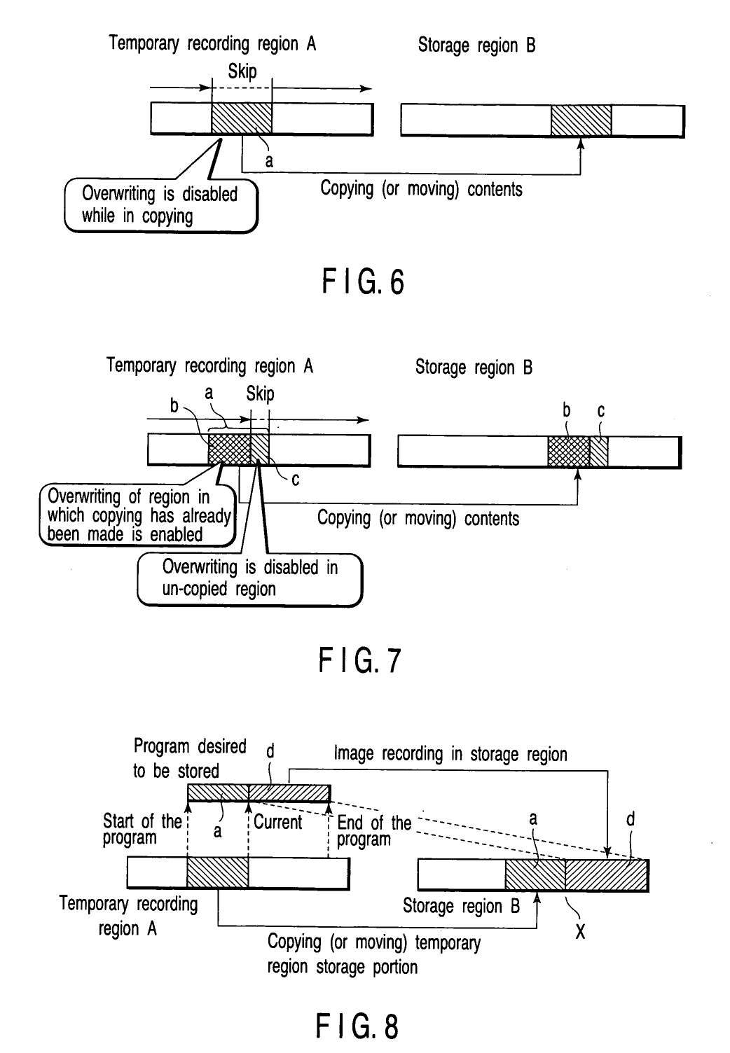

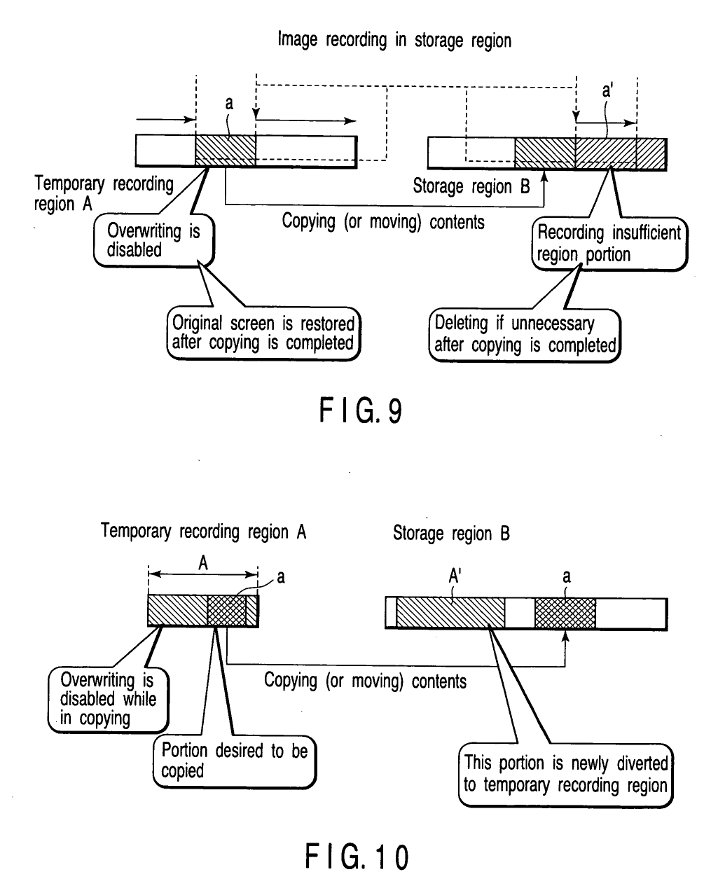

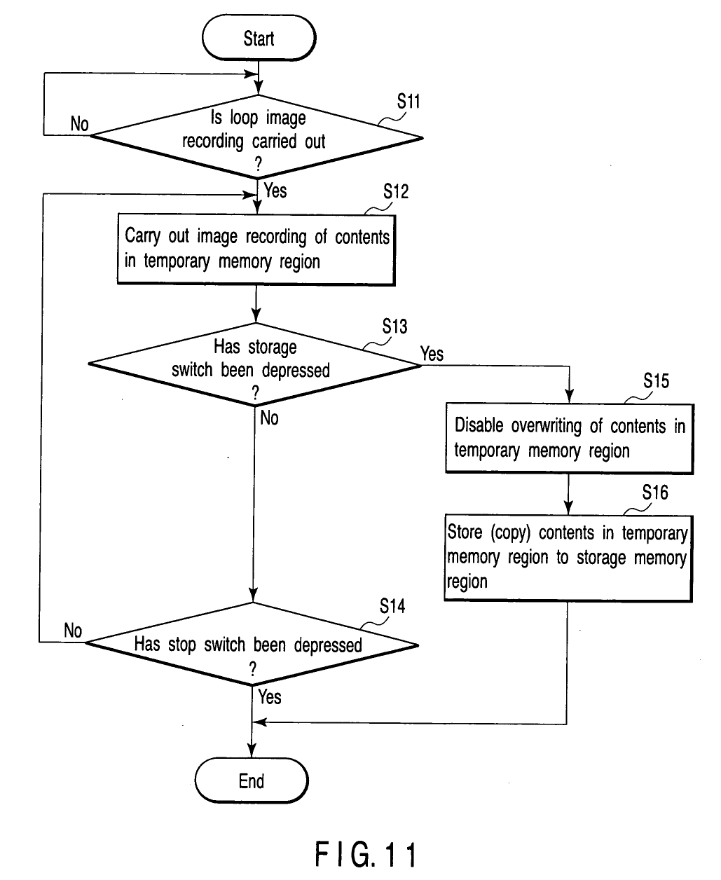

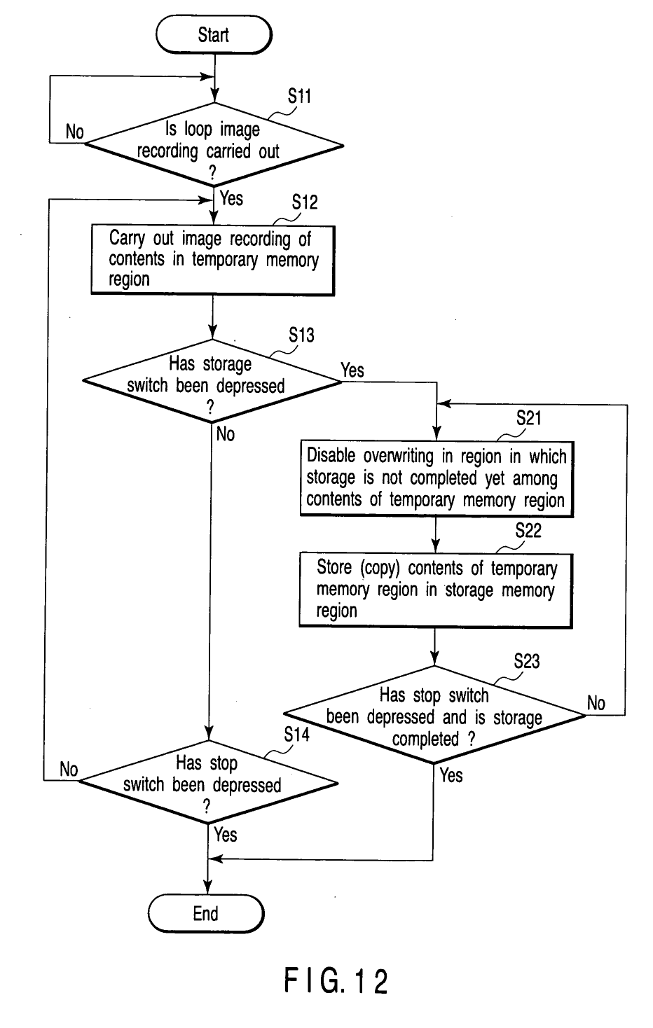

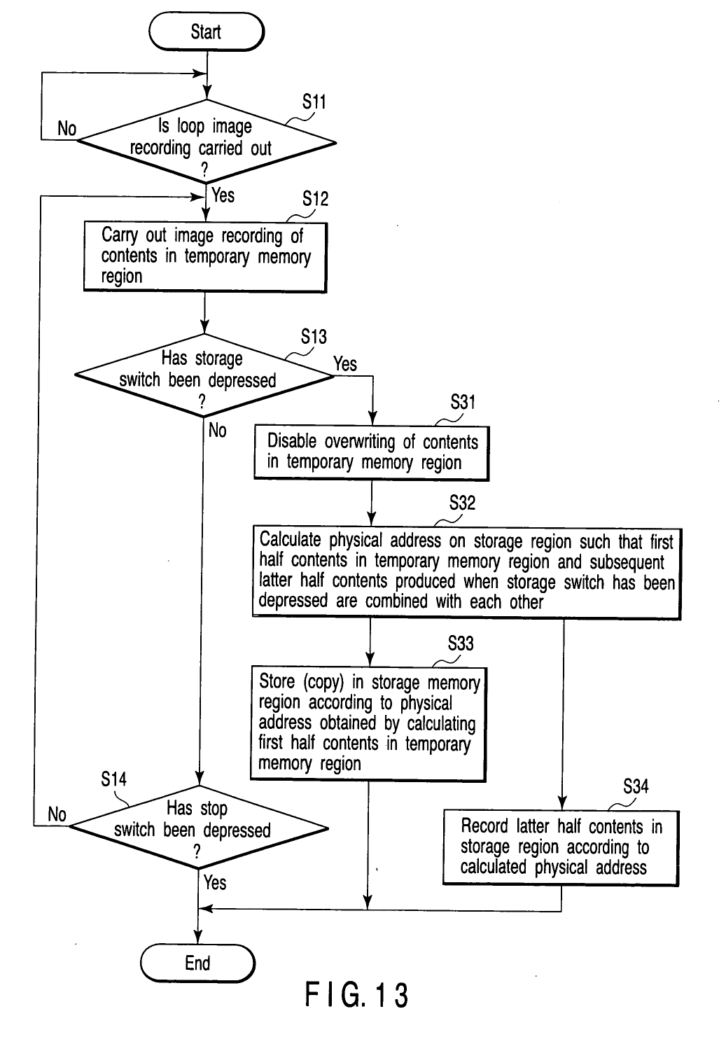

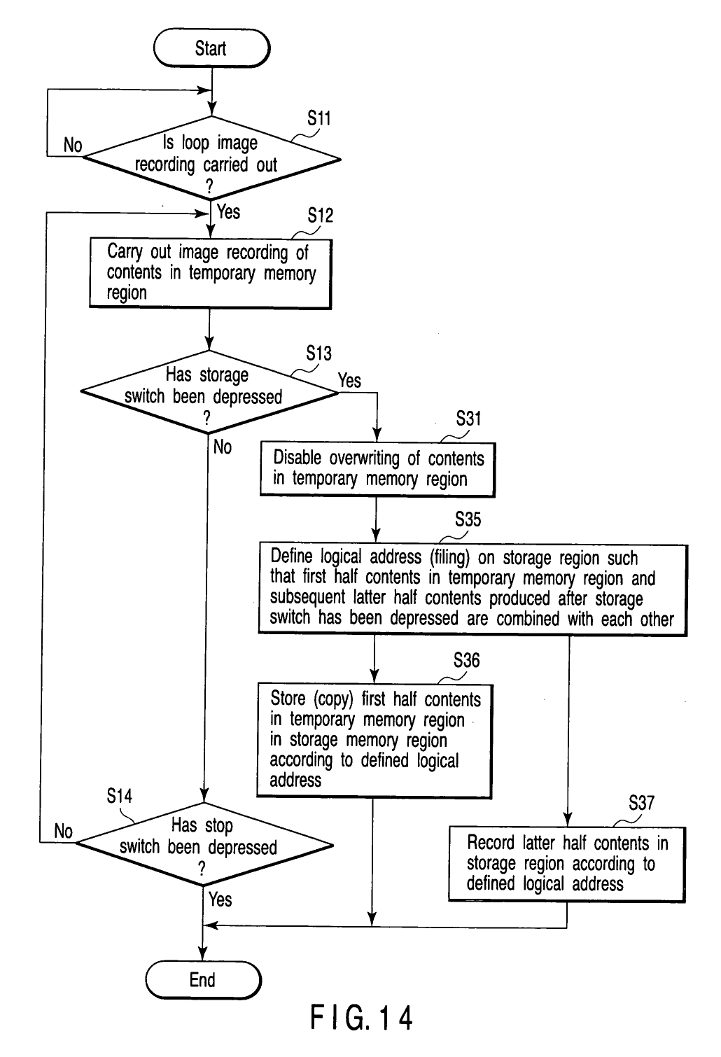

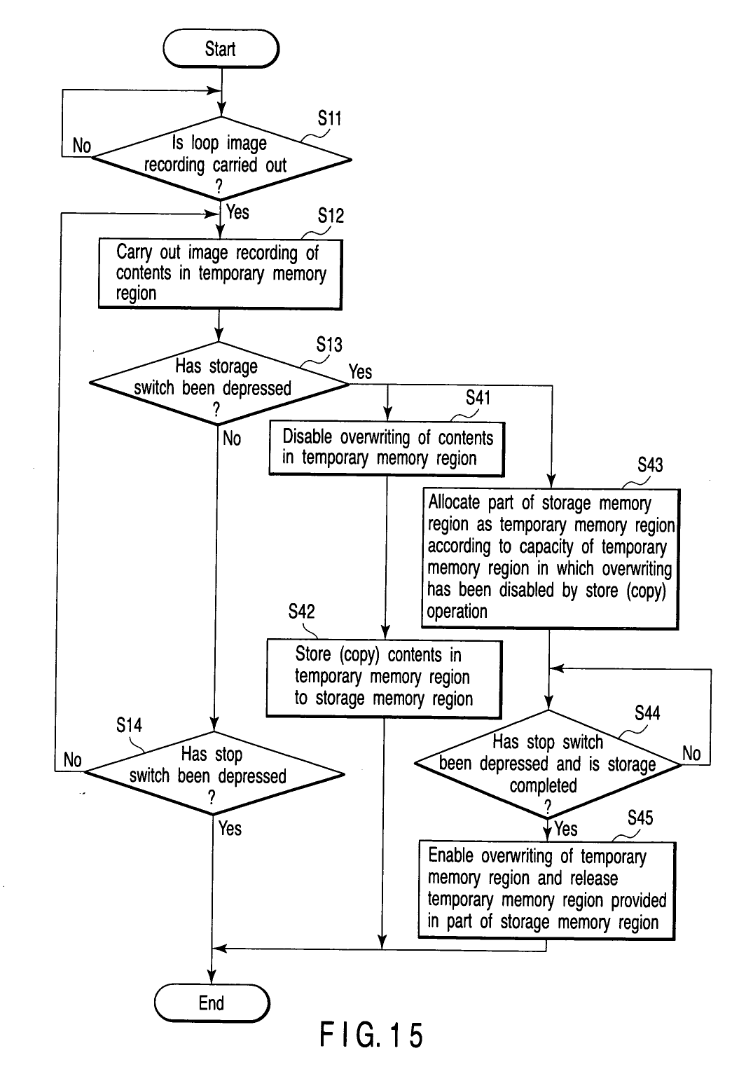

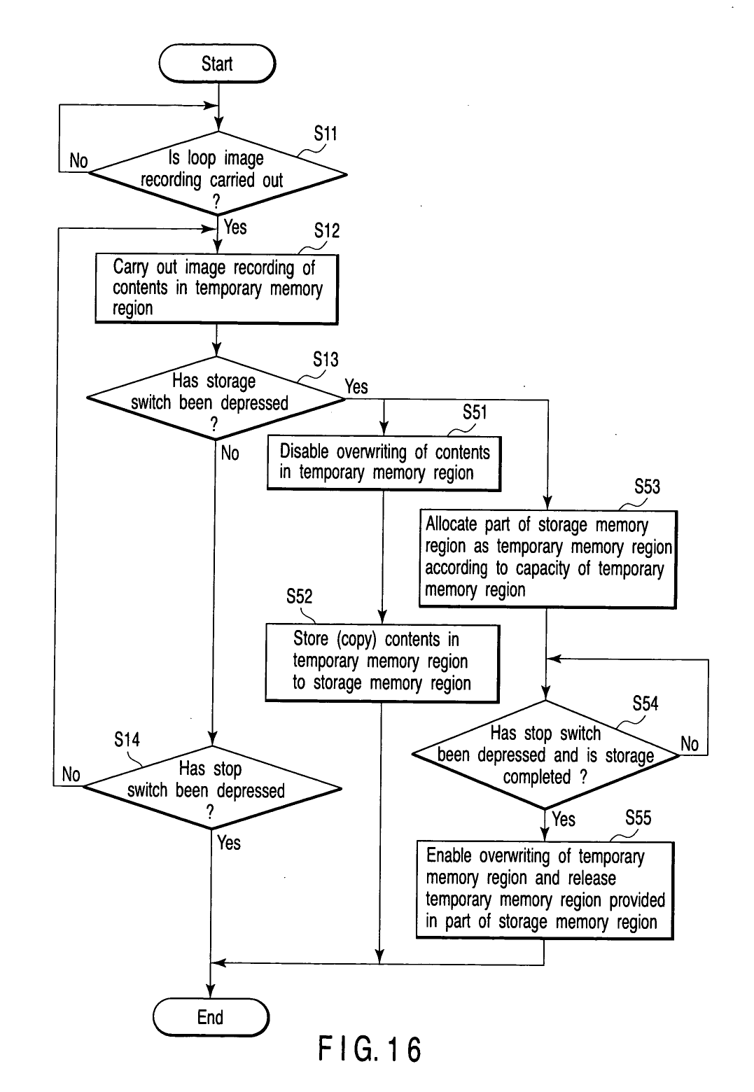

Now, loop image recording and storage image recording processing operations according to an embodiment of the present invention will be described below in detail with reference to the accompanying drawings. FIG. 5 is an illustrative view showing an example of a remote controller device for operating the broadcast recording apparatus; FIG. 6 is an illustrative view showing an example of a first copy processing operation of the broadcast recording apparatus; FIG. 7 is an illustrative view showing an example of a second copy processing operation of the broadcast recording apparatus; FIG. 8 is an illustrative view showing an example of third and fourth copy processing operations of the broadcast recording apparatus; FIG. 9 is an illustrative view showing an example of a fifth copy processing operation of the broadcast recording apparatus; FIG. 10 is an illustrative view showing an example of a sixth copy processing operation of the broadcast recording apparatus; FIG. 11 is a flow chart showing an example of the first copy processing operation of the broadcast recording apparatus; FIG. 12 is a flow chart showing an example of the second copy processing operation of the broadcast recording apparatus; FIG. 13 is a flow chart showing an example of the third copy processing operation of the broadcast recording apparatus; FIG. 14 is a flow chart showing an example of the fourth copy processing operation of the broadcast recording apparatus; FIG. 15 is a flow chart showing an example of the fifth copy processing operation of the broadcast recording apparatus; and FIG. 16 is a flow chart showing an example of the sixth copy processing operation of the broadcast recording apparatus.

(Loop Image Recording and Storage Image Recording)

First, an outline of loop image recording and storage image recording will be described here.

Loop image recording is provided as a method for continuously recording broadcast contents from a BS/CS analog tuner unit 12 in a temporary storage region A within a range of a time limit such as six hours, for example, by using the temporary storage region A of a hard disk drive 18. Here, if an image recording time exceeds a time limit such as six hours, overwrite image recording is carried out from the oldest region in the temporary storage region A, whereby an image recording/reproducing processing operation of broadcast contents is carried out while saving a memory capacity.

However, in loop image recording, there occurs a failure that broadcast contents are overwritten and erased by image recording of subsequent other broadcast contents while no reproduction is carried out although image recording has been completed. Therefore, a storage region B is used to avoid such a circumstance. A copy processing operation (or move processing operation) to the storage region B of the broadcast contents is carried out for broadcast contents being in loop image recording or broadcast contents obtained after loop image recording has been completed, whereby the broadcast contents can be stored for a long period of time.

However, while the broadcast contents being recorded in a temporary image recording region are subjected to a copy processing operation for a storage region, loop image recording may be further made. Therefore, there occurs a failure that, depending on the process of the loop image recording, the broadcast contents being in copy processing operation is erased, although the copy processing operation has not been completed yet. In order to avoid such a failure or the like, it is preferable to carry out an embodiment specified in accordance with the following flow chart or the like.

### First Embodiment

### Disabling Overwriting of Broadcast Contents: FIGS. 6 and 11

According to a first embodiment, there is provided a broadcast recording apparatus for disabling overwriting with respect to a first half portion of broadcast contents being recorded in a temporary memory region A while in copy processing operation of broadcast contents in a recording region B, thereby reliably making loop image recording.

That is, in a broadcast recording/reproducing apparatus 10 according to an embodiment of the present invention, for example, in a state in which broadcast contents from a terrestrial analog tuner unit 12 or the like and a reproduction video image reproduced by means of a voice and video image processing unit 24 are displayed on a display 26, a user depresses a remote controller's loop image recording switch 51, whereby loop image recording is made (step S11).

Upon receiving an operating signal from the loop image recording switch 51, a control unit 30 and a loop image recording/storage image recording control unit 42 supply broadcast contents from a terrestrial tuner unit 13 or the like to an encoder unit 21. The broadcast contents encoded by means of the encoder unit 21 are recorded in a temporary memory region A of a hard disk drive 18 via a signal editing unit 20 (step S12).

Further, when a remote controller's storage image recording switch 52 is depressed by a user (step S13), the overwriting of broadcast contents “a” of the temporary memory region A is disabled by working of the control unit 30 and the loop image recording/storage image recording control unit 42 (step S15). Then, the broadcast contents “a” are stored (copied or moved) in the storage region B (step S16).

In addition, when a user depresses a stop switch 53 without depressing the remote controller's storage image recording switch 52 (step S14), the loop image recording then terminates.

In this manner, there is no danger that the broadcast contents “a” are overwritten and erased due to a loop image recording processing operation or the like of next broadcast contents while in copy processing operation. Thus, a user can reliably carry out a copy or move processing operation.

### Second Embodiment

### Disabling Overwriting of Un-Copied Broadcast Contents: FIGS. 7 and 12

According to a second embodiment, there is provided a broadcast recording apparatus for disabling overwriting of only an un-copied region, among a first half portion of the broadcast contents being recorded in a temporary memory region A while in copy processing operation of broadcast contents in a recording region B, thereby reducing an effect of overwrite disabling to the minimum and reliably carrying out loop image recording.

That is, in the broadcast recording/reproducing apparatus 10 according to an embodiment of the present invention, for example, in a state in which a reproduction video image obtained by reproducing the broadcast contents from a terrestrial analog tuner unit 13 or the like by means of a voice and video image processing unit 24 is displayed on a display 26, a user depresses a remote controller's loop image recording switch 51, whereby loop image recording is carried out (step S11).

Upon receiving an operating signal from the loop image recording switch 51, a control unit 30 and a loop image recording/storage image recording control unit 42 supply the broadcast contents from the terrestrial tuner unit 13 or the like to an encoder unit 21. The broadcast contents encoded by means of the encoder unit 21 are recorded in a temporary memory region A of a hard disk drive 18 via a signal editing unit 20 (step S12).

Further, when a remote controller's storage image recording switch 52 is depressed by a user (step S13), the overwriting of only an un-copied region “c” among the broadcast contents “a” of the temporary memory region A, is disabled by working of the control unit 30 and the loop image recording/storage image recording control unit 42, as shown in FIG. 7 (step S21). Then, the broadcast contents “a” are stored (copied or moved) to a storage region B (step S22). Such a processing operation (S21 or S22) is continued until a stop switch 53 of a remote controller R is depressed and a copy processing operation is completed (step S23).

When the user depresses the stop switch 53 without depressing the remote controller's storage image recording switch 52 (step S14), the loop image recording then terminates.

In this manner, there is no danger that the broadcast contents are overwritten and erased due to a loop image recording processing operation or the like of next broadcast contents while in copy processing operation. Thus, a user can reliably carry out a copy or move processing operation.

### Third and Fourth Embodiments Physical Address and Logical Address: FIGS. 8, 13, and 14

A third embodiment specifies a broadcast recording apparatus for, in a copy processing operation of broadcast contents in a recording region B, so that a first half portion “a” of broadcast contents having been recorded in a temporary recording region A and being to be copied to a storage region B therefrom, and a latter half portion “d” of the broadcast contents being to be recorded in the storage region B therefrom are continuously combined with each other in the storage region B, calculating a physical address on a storage region, and, based on the thus calculated physical address, carrying out a copy processing operation of the first half portion of the broadcast contents and a recording processing operation of the latter half portion of the broadcast contents.

In addition, a fourth embodiment specifies a broadcast recording apparatus for, instead of calculating a physical address so that a first half portion “a” of broadcast contents and a latter half portion “d” thereof to be recorded in a storage region B therefrom are continuously combined with each other in a storage region B, defining a logical address of broadcast contents after copied as a continuous address, and, by definition of this continuous logical address, carrying out a copy processing operation of the first half portion of the broadcast contents and a recording processing operation of the latter half portion of the broadcast contents.

That is, in the broadcast recording/reproducing apparatus 10 according to an embodiment of the present invention, for example, in a state in which a reproduction video image obtained by reproducing the broadcast contents from a terrestrial analog tuner unit 13 or the like by means of a voice and video image processing unit 24 is displayed on a display 26, a user depresses a remote controller's loop image recording switch 51, whereby loop image recording is carried out (step S11).

Upon receiving an operating signal from the loop image recording switch 51, a control unit 30 and a loop image recording/storage image recording control unit 42 supply the broadcast contents from the terrestrial tuner unit 13 or the like to an encoder unit 21. The broadcast contents encoded by means of the encoder unit 21 are recorded in a temporary memory region A of a hard disk drive 18 via a signal editing unit 20 (step S12).

Further, when a remote controller's storage image recording switch 52 is depressed by a user (step S13), the overwriting of broadcast contents “a” of the temporary memory region A is disabled by working of the control unit 30 and the loop image recording/storage image recording control unit 42.

Then, by working of the control unit 30 and the loop image recording/storage image recording control unit 42, a physical address X on a storage region B is calculated so that a first half portion “a” of broadcast contents C having been recorded in the temporary memory region A and being to be copied to the storage region B therefrom, and a later half portion “d” of the broadcast contents C to be recorded in the storage region B therefrom are continuously combined with each other in the storage region B (step S32). Then, as shown in FIG. 8, based on this physical address X, a copy processing operation of the first half portion “a” of the broadcast contents is carried out (step S33), and at the same time, based on this physical address X, a recording processing operation of the latter half portion “d” of the broadcast contents in the recording region B is carried out (step S34).

In addition, when the user depresses a stop switch 53 without depressing the remote controller's storage image recording switch 52 (step S14), the loop image recording then terminates.

In this manner, a copy processing operation of broadcast contents to a storage region can be reliably carried out.

In addition, in the fourth embodiment, in a file system used in the control unit 30 and the loop image recording/storage image recording control unit 42, a logical address (filing) is defined so as to produce continuous management data so that a first half portion “a” and a latter half portion “d” of broadcast contents are continuously combined with each other (step S35). Here, a physical address may not always be continuous.

Then, as shown in FIG. 8, based on this logical address, a copy processing operation of the first half portion “a” of the broadcast contents is carried out (step S36). Similarly, based on this logical address, a recording processing operation of the latter half portion “d” of the broadcast contents in the recording region B is carried out (step S37).

In addition, when the user depresses the stop switch 53 without depressing the remote controller's storage image recording switch 52 (step S14), the loop image recording then terminates.

In this manner, there is no danger that the broadcast contents are overwritten and erased due to a loop image recording processing operation or the like of next broadcast contents while in copy processing operation. Thus, a user can reliably carry out a copy or move processing operation.

### Fifth Embodiment

### Providing Temporary Recording Region for First Half Portion “a” of Broadcast Contents: FIGS. 9 and 15

A fifth embodiment specifies a broadcast recording apparatus for providing a temporary memory region a′ for a first half portion “a” of broadcast contents in a storage region B while in copy processing operation of the broadcast contents in a recording region B.

That is, in a broadcast recording/reproducing apparatus 10 according to an embodiment of the present invention, for example, in a state in which a reproduction video image produced by reproducing broadcast contents from a terrestrial analog tuner unit 13 or the like by means of a voice and video image processing unit 24 is displayed on a display 26, a user depresses a remote controller's loop image recording switch 51, whereby loop image recording is carried out (step S11).

Upon receiving an operating signal from the loop image recording switch 51, a control unit 30 and a loop image recording/storage image recording control unit 42 supply the broadcast contents from the terrestrial tuner unit 13 or the like to an encoder unit 21. The broadcast contents encoded by means of the encoder unit 21 are recorded in a temporary memory region A of a hard disk drive 18 via a signal editing unit 20 (step S12).

Further, when a remote controller's storage image recording switch 52 is depressed by a user (step S13), the overwriting of broadcast contents “a” of the temporary memory region A is disabled by working of the control unit 30 and the loop image recording/storage image recording control unit 42 (step S41). Then, the broadcast contents “a” are stored (copied or moved) to a storage region B (step S42).

At the same time, as shown in FIG. 8, part of the storage region B is allocated as a temporary memory region a′ according to a capacity of the temporary memory region A whose overwriting is disabled by means of storage (copy) (step S43).

In this manner, the capacity of the temporary memory region can be reliably allocated, thus enabling stable loop image recording.

Then, if a stop switch 53 of a remote controller R is depressed, and further, a copy processing operation is completed (step S44), the overwrite disabling of the broadcast contents “a” of the temporary memory region A is released, and the temporary memory region a′ provided in part of the storage region B is released after broadcast contents have been reproduced (step S45).

In addition, when the user depresses the stop switch 53 without depressing the remote controller's storage image recording switch 52 (step S14), the loop image recording then terminates.

In this manner, the broadcast contents “a” can avoid an insufficient capacity of the temporary memory region A while in copy processing operation, thus enabling stable loop image recording.

### Sixth Embodiment

### Providing Temporary Recording Region A′ Having the Same Capacity as that of Temporary Recording Region A: FIGS. 10 and 16

A sixth embodiment specifies a broadcast recording apparatus for providing a temporary recording region A′ having the same capacity as that of a temporary recording region A in a storage region B while in copy processing operation of broadcast contents in a recording region B.

That is, in a broadcast recording/reproducing apparatus 10 according to an embodiment of the present invention, for example, in a state in which a reproduction video image produced by reproducing broadcast contents from a terrestrial analog tuner unit 13 or the like by means of a voice and video image processing unit 24 is displayed on a display 26, a user depresses a remote controller's loop image recording switch 51, whereby loop image recording is carried out (step S11).

Upon receiving an operating signal from the loop image recording switch 51, a control unit 30 and a loop image recording/storage image recording control unit 42 supply the broadcast contents from the terrestrial tuner unit 13 or the like to an encoder unit 21. The broadcast contents encoded by means of the encoder unit 21 are recorded in a temporary memory region A of a hard disk drive 18 via a signal editing unit 20 (step S12).

Further, when a remote controller's storage image recording switch 52 is depressed by a user (step S13), the overwriting of broadcast contents “a” of the temporary memory region A is disabled by working of the control unit 30 and the loop image recording/storage image recording control unit 42 (step S41). Then, the broadcast contents “a” are stored (copied or moved) to a storage region B (step S42).

At the same time, as shown in FIG. 10, a temporary memory region A′ having the same capacity as that of the temporary memory region A is allocated in the storage region B (step S43).

In this manner, the capacity of the temporary memory region can be reliably allocated, thus enabling stable loop image recording.

Then, if a stop switch 53 of a remote controller R is depressed, and further, a copy processing operation is completed (step S44), the overwrite disabling of the broadcast contents “a” of the temporary memory region A is released, and the temporary memory region A′ provided in part of the storage region B is released after broadcast contents have been reproduced (step S45).

In addition, when a user depresses the stop switch 53 without depressing the remote controller's storage image recording switch 52 (step S14), the loop image recording then terminates.

In this manner, the broadcast contents “a” can avoid an insufficient capacity of the temporary memory region A while in copy processing operation, thus enabling stable loop image recording.

In accordance with a variety of embodiments described above, while one skilled in the art can achieve the present embodiment, further, a variety of modified examples of these embodiments can be readily conceived by one skilled in the art, making it possible to apply to a variety of embodiments even if one does not have any inventive ability. Therefore, the present invention covers a broad scope without departing from the disclosed principle and novel features and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast recording apparatus, comprising:
a tuner unit which receives a broadcast signal, demodulates the received signal, and outputs broadcast contents;
a temporary recording region portion which records the broadcast contents outputted from the tuner unit;
a storage region portion which records the broadcast contents outputted from the tuner unit; and
a control unit which makes control to record the broadcast contents within a range of a time limit in the temporary recording region portion, carry out loop image recording for making overwrite recording in the temporary recording region portion in which recording has been made if the time limit is exceeded, copy the broadcast contents recorded in the temporary recording region portion to the storage region portion if an operating signal is supplied while the loop image recording is carried out, and disable overwriting of the broadcast contents in the temporary recording region portion until the copy is completed.

2. The broadcast recording apparatus according to claim 1, further comprising a display which displays a video image according to the broadcast contents.

3. The broadcast recording apparatus according to claim 1, wherein the control unit makes control to disable overwriting of a portion at which the copy is not completed with respect to the broadcast contents of the temporary recording region portion until the copy is completed.

4. The broadcast recording apparatus according to claim 1, wherein the control unit makes control to calculate a physical address on the storage region portion so that, if the operating signal is supplied, a first half portion of the broadcast contents having been recorded in the temporary recording region portion and being to be recorded in the storage region portion therefrom, and a latter half portion of the broadcast contents to be recorded in the storage region portion therefrom are continuously combined with each other in the storage region portion, and, based on the thus calculated physical address, carry out a copy processing operation of the first half portion of the broadcast contents and a recording processing operation of the latter half portion of the broadcast contents.

5. The broadcast recording apparatus according to claim 1, wherein the control unit makes control to define a logical address on the storage region portion so that, if the operating signal is supplied, a first half portion of the broadcast contents having been recorded in the temporary recording region portion and being to be recorded in the storage region portion therefrom, and a latter half portion of the broadcast contents to be recorded in the storage region portion therefrom are continuously combined with each other in the storage region portion, and, by generating a file of the broadcast contents based on the thus defined logical address, carry out a copy processing operation of the first half portion of the broadcast contents and a recording processing operation of the latter half portion of the broadcast contents.

6. The broadcast recording apparatus according to claim 1, wherein the control unit makes control to allocate a memory capacity of a first half portion of the broadcast contents being recorded in the temporary recording region portion as a new temporary recording region in the storage region portion if the operating signal is supplied, and, use the new temporary recording region when the loop image recording of second broadcast contents that are different from the broadcast contents is instructed.

7. The broadcast recording apparatus according to claim 1, wherein the control unit makes control to allocate a memory capacity of the temporary recording region portion as a new temporary recording region in the storage region portion if the operating signal is supplied, and use the new temporary recording region when the loop image recording of second broadcast contents that are different from the broadcast contents is instructed.

8. The broadcast recording apparatus according to claim 1, wherein the control unit makes control to execute the loop image recording upon receiving an operating signal produced by depressing of a loop image recording switch of a remote controller device and execute the copy processing operation upon receiving an operating signal produced by depressing of a storage image recording switch of the remote controller device.

9. The broadcast recording apparatus according to claim 1, wherein the temporary recording region portion and the storage region portion are memory regions provided in the same hard disk drive.

10. The broadcast recording apparatus according to claim 1, wherein the temporary recording region portion and the storage region portion are memory regions provided in first and second hard disk drives, respectively, that are different from each other.

11. A broadcast recording method, comprising:
receiving a broadcast signal, demodulating the received signal, and outputting broadcast contents;
recording the broadcast contents within a range of a time limit in a temporary recording region portion, and carrying out loop image recording for making overwrite recording in the temporary recording region portion in which recording has been made if the time limit is exceeded; and
copying the broadcast contents recorded in the temporary recording region portion to the storage region portion if an operating signal is supplied while the loop image recording is carried out, and then, disabling overwriting of the broadcast contents in the temporary recording region portion until the copy is completed.

12. The broadcast recording method according to claim 11, wherein a video image according to the broadcast contents is displayed on a display.

13. The broadcast recording method according to claim 11, wherein overwriting of a portion at which the copy is not completed is disabled with respect to the broadcast contents in the temporary recording region portion until the copy is completed.

14. The broadcast recording method according to claim 11, wherein a physical address on the storage region portion is calculated so that, if the operating signal is supplied, a first half portion of the broadcast contents having been recorded in the temporary recording region portion and being to be recorded in the storage region portion therefrom, and a latter half portion of the broadcast contents to be recorded in the storage region portion therefrom are continuously combined with each other in the storage region portion, and, based on the thus calculated physical address, a copy processing operation of the first half portion of the broadcast contents and a recording processing operation of the latter half portion of the broadcast contents are carried out.

15. The broadcast recording method according to claim 11, wherein a logical address on the storage region portion is defied so that, if the operating signal is supplied, a first half portion of the broadcast contents having been recorded in the temporary recording region portion and being to be recorded in the storage region portion therefrom, and a latter half portion of the broadcast contents to be recorded in the storage region portion therefrom are continuously combined with each other in the storage region portion, and, by generating a file of the broadcast contents based on the thus defined logical address, a copy processing operation of the first half portion of the broadcast contents and a recording processing operation of the latter half portion of the broadcast contents are carried out.

16. The broadcast recording method according to claim 11, wherein a memory capacity of a first half portion of the broadcast contents being recorded in the temporary recording region portion is allocated as a new temporary recording region in the storage region portion if the operating signal is supplied, and the new temporary recording region is used when the loop image recording of second broadcast contents that are different from the broadcast contents is instructed.

17. The broadcast recording method according to claim 11, wherein a memory capacity of the temporary recording region portion is allocated as a new temporary recording region in the storage region portion if the operating signal is supplied, and the new temporary recording region is used when the loop image recording of second broadcast contents that are different from the broadcast contents is instructed.

18. The broadcast recording method according to claim 11, wherein the loop image recording is executed upon receiving an operating signal produced by depressing of a loop image recording switch of a remote controller device and the copy processing operation is executed upon receiving an operating signal produced by depressing of a storage image recording switch of the remote controller device.
